(19) United States
(12) Patent Application Publication
(10) Pub. No.: US 2021/0390476 A1
(43) Pub. Date: Dec. 16, 2021

(54) MAINTENANCE IMPROVEMENT SUPPORT DEVICE AND MAINTENANCE IMPROVEMENT SUPPORT METHOD

(71) Applicant: Hitachi, Ltd., Tokyo (JP)

(72) Inventors: Toshiaki KONO, Tokyo (JP); Yasuharu NAMBA, Tokyo (JP)

(21) Appl. No.: 17/194,396

(22) Filed: Mar. 8, 2021

(30) Foreign Application Priority Data
Jun. 12, 2020 (JP) 2020-102275

(51) Int. Cl. G06Q 10/06; G06N 5/02

(52) U.S. Cl. CPC G06Q 10/06312; G06Q 10/06393; G06Q 10/06398; G06N 5/022

(57) ABSTRACT

To efficiently implement a desired maintenance task improvement by formulating an optimum maintenance task and IoT introduction plan. An IoT comprehensive scenario generation unit 7000 that extracts an applicable IoT menu in IoT menus from a feature of a maintenance task that is a target, and generates an IoT application simulation setting, an IoT adjustment unit 8000 that executes IoT application simulation for the IoT application simulation setting, a maintenance task simulation unit 9000 that executes maintenance task simulation that incorporates IoT, and an evaluation unit 4000 that gives an instruction to the IoT adjustment unit 8000 to implement a next IoT application simulation so as to optimize an improvement by determining presence or absence of a task improvement based on a result of the maintenance task simulation, and presents an improvement result when the IoT application simulation is completed are included.

### CROSS-REFERENCE TO RELATED APPLICATION

The present application claims priority from Japanese application JP 2020-102275, filed on Jun. 12, 2020, the contents of which is hereby incorporated by reference into this application.

### TECHNICAL FIELD

The present invention relates to a maintenance improvement support device and a maintenance improvement support method.

### BACKGROUND ART

In many areas such as infrastructure, railroads, industrial equipment, and medical equipment, it is necessary to maintain a predetermined performance by continuously implementing maintenance after the introduction of assets. In maintenance, it is necessary to analyze a state of a target asset and an implementation status of the maintenance, and formulate and implement an appropriate maintenance task design.

With the development of information technology in recent years, maintenance can be performed at an appropriate content and timing by using IoT technology such as diagnosis technology, in which states of assets and task implementation are collected with sensors, the states are grasped and analyzed, or the future is predicted, so that it is possible to improve reliability while reducing a maintenance cost.

However, for that purpose, it is necessary to introduce a maintenance process different from the process in the related art based on an effect and operation of the Internet of Things (IoT) technology, and along with this, maintenance task resources such as the number of personnel, necessary skills, and equipment will change significantly. Further, the introduction of a new IT technology requires system to be updated, and depending on a sensor and an analysis method, IT resources such as large-capacity storage and large computing power are required.

Therefore, it is necessary to appropriately implement the design of the maintenance task and IoT. In particular, when there are a plurality of assets or asset failures, it is necessary to determine a range and a performance of the IoT technology to be applied, if the range and a scale of the introduction are not appropriate, there is a problem that the cost increases and the introduction effect cannot be obtained, and a scale of investment becomes an issue, which may not lead to the task improvement. Further, the appropriate IoT technology may differ depending on an embodiment of the maintenance.

Therefore, in the planning and design of the maintenance task and IoT, it is necessary to formulate an introduction plan of the IT technology that matches features of the maintenance task, and to verify whether effects of the introduced IoT match task improvement goals.

PTLs 1 and 2 are examples of technologies that support the formulation of task improvement plans for asset operation and maintenance and the estimation of effects.

PTL 1 is used for formulating a plant introduction plan by simulating a future operation cost or the like from past operation data in order to formulate an asset introduction plan in a plant.

PTL 2 predicts an operation cost and a maintenance cost due to a combination of operation conditions for operating an asset and an operator in a plant, and presents an optimum combination.

### CITATION LIST

### Patent Literature

PTL 1: JP-A-2005-258816

PTL 2: JP-A-2006-244288

### SUMMARY OF INVENTION

### Technical Problem

There are implementation difficulties in formulating and verifying the introduction plan of an IoT system for the maintenance task. Since it is necessary to handle a wide variety of assets in maintenance, it is necessary to consider in detail what kind of IoT is introduced for which asset to improve the task. Further, it is necessary to estimate the introduction effect and verify whether the investment effect is sufficient.

In many cases, effect verification is implemented by IoT application experiments. However, due to the existence of a wide variety of assets and various maintenance tasks that occur for each asset, it is extremely difficult to perform IoT introduction tests for all assets. Further, in limited tests, the improvement effects of the maintenance tasks are determined by including relationships between many related tasks and a subjective surplus status of maintenance resources such as workers, so that quantitative estimation of the effects cannot be obtained.

Therefore, it is conceivable to verify the effects by building a simulation of the maintenance tasks and incorporating the effects of IoT into the simulation.

Accordingly, it can be expected that it is possible to verify the effects when various types of IoT are incorporated into any maintenance target asset. However, even in that case, when there is a wide variety of maintenance target assets, or when there are various types of available IoT, finding of an optimal solution by trying a large number of these combinations may result in a very large amount of simulation calculation, so that it is necessary to verify an efficient IoT introduction plan.

The invention has been made in view of the above problems, and is to provide a maintenance improvement support device and a maintenance improvement support method that can implement verification of an IoT effect using features of a maintenance task, which is a target, and efficiently implement a desired maintenance task improvement by formulating an optimum maintenance task and IoT introduction plan.

### Solution to Problem

In order to solve the above problems, a maintenance improvement support device according to one aspect of the invention includes: maintenance task log data in which an implementation record of a maintenance task, which is a target, is stored; task knowledge data in which knowledge related to the maintenance task is recorded; and a simulation basic setting generation unit configured to generate, based on the implementation record and the knowledge of the maintenance task, a basic simulation setting that reproduces a current maintenance implementation status; an IoT menu in which an available IoT solution candidate, and an effect and an application method thereof are recorded; an IoT comprehensive scenario generation unit configured to extract an applicable IoT menu in the IoT menu from a feature of the maintenance task that is a target, determine or prioritize simulation elements such as an asset and an employee as actual application targets based on the feature of the maintenance task, and generate an IoT application simulation setting that incorporates available IoT into the basic simulation setting; an IoT adjustment unit configured to sequentially execute IoT application simulation while selecting the asset and the employee who actually perform an IoT application evaluation for the IoT application simulation setting; a maintenance task simulation unit configured to execute maintenance task simulation that incorporates the IoT; a simulation result storage unit configured to store a result of the maintenance task simulation that has already been implemented; and an evaluation unit configured to give an instruction to the IoT adjustment unit to implement a next IoT application simulation so as to optimize an improvement by determining presence or absence of a task improvement based on the stored result of the maintenance task simulation, and present an improvement result when the IoT application simulation is completed.

### Advantageous Effect

According to the invention, it is possible to implement verification of an IoT effect using features of a maintenance task, which is a target, and efficiently implement a desired maintenance task improvement by formulating an optimum maintenance task and IoT introduction plan.

### BRIEF DESCRIPTION OF DRAWINGS

FIG. 1 is a diagram showing a schematic configuration of a maintenance improvement support device according to an embodiment.

FIG. 2 is a diagram showing an example of maintenance task log data of the maintenance improvement support device according to the embodiment.

FIG. 3 is a diagram showing an example of a list of maintenance target assets stored in task knowledge data of the maintenance improvement support device according to the embodiment.

FIG. 4 is a diagram showing an example of a list of employees stored in the task knowledge data of the maintenance improvement support device according to the embodiment.

FIG. 5 is a diagram showing an example of an IoT menu of the maintenance improvement support device according to the embodiment.

FIG. 6 is a flowchart showing an example of an operation of a simulation basic setting generation unit of the maintenance improvement support device according to the embodiment.

FIG. 7 is a diagram showing an example of a start screen displayed on an HMI of the maintenance improvement support device according to the embodiment.

FIG. 8 is a diagram showing an example of a failure handling work occurrence model generated by the simulation basic setting generation unit of the maintenance improvement support device according to the embodiment.

FIG. 9 is a diagram showing an example of a work specification generated by the simulation basic setting generation unit of the maintenance improvement support device according to the embodiment.

FIG. 10 is a diagram showing an example of a movement time table generated by the simulation basic setting generation unit of the maintenance improvement support device according to the embodiment.

FIG. 11 is a diagram showing an example of a maintenance simulation basic setting generated by the simulation basic setting generation unit of the maintenance improvement support device according to the embodiment.

FIG. 12 is a flowchart showing an example of an operation of an IoT comprehensive scenario unit of the maintenance improvement support device according to the embodiment.

FIG. 13 is a diagram for showing an identification method of a maintenance type in the maintenance improvement support device according to the embodiment.

FIG. 14 is a diagram showing an example of a result of an IoT application group generated by the IoT comprehensive scenario unit of the maintenance improvement support device according to the embodiment.

FIG. 15 is a diagram showing an example of a result of an IoT application priority generated by the IoT comprehensive scenario unit of the maintenance improvement support device according to the embodiment.

FIG. 16 is a diagram showing an example of a diagnosis support agent implemented by the IoT comprehensive scenario unit of the maintenance improvement support device according to the embodiment.

FIG. 17 is a diagram showing an example of a failure prediction agent implemented by the IoT comprehensive scenario unit of the maintenance improvement support device according to the embodiment.

FIG. 18 is a diagram showing an example of a processing result of an IoT application maintenance template generated by the IoT comprehensive scenario unit of the maintenance improvement support device according to the embodiment.

FIG. 19 is a flowchart showing an example of an operation of an IoT adjustment unit of the maintenance improvement support device according to the embodiment.

FIG. 20 is a diagram showing an example of a workflow of a worker of the maintenance improvement support device according to the embodiment.

FIG. 21 is a diagram showing an example of a simulation work log generated by a maintenance task simulation unit of the maintenance improvement support device according to the embodiment.

FIG. 22 is a flowchart showing an example of an operation of an evaluation unit of the maintenance improvement support device according to the embodiment.

FIG. 23 is a diagram showing an example of an evaluation target KPI for evaluation by the evaluation unit of the maintenance improvement support device according to the embodiment.

FIG. 24 is a diagram showing an example of simulation result storage stored by a simulation result storage unit of the maintenance improvement support device according to the embodiment.

FIG. 25 is a diagram showing an example of an evaluation result presentation by the evaluation unit of the maintenance improvement support device according to the embodiment.

### DESCRIPTION OF EMBODIMENTS

Hereinafter, an embodiment of the invention will be described with reference to the drawings. The embodiment described below do not limit the invention according to the claims, and all of the elements and combinations thereof described in the embodiments are not necessarily essential to the solution of the invention.

In all the drawings for showing the embodiment, units having the same function are denoted by the same reference numerals, and repetitive descriptions thereof are omitted.

Further, in the following description, an expression such as “xxx data” may be used as an example of information, but a data structure of the information may be any. That is, “xxx data” can be referred to as an “xxx table” to show that the information does not depend on the data structure. Further, “xxx data” may be simply referred to as “xxx”. Then, in the following description, a configuration of each type of information is an example, and the information may be divided and stored, or may be combined and stored.

In the following description, there is a case where processing is described using a “program” as a subject, and since the program is executed by a processor (for example, a central processing unit (CPU)) to perform a determined processing while appropriately using a memory resource (for example, a memory) and/or a communication interface device (for example, a port), the subject of the processing may be the program. The processing described using the program as the subject may be processing performed by the processor or a computer including the processor.

A maintenance improvement support device of the present embodiment may have the following configuration as an example.

That is, the maintenance improvement support device of the present embodiment includes: maintenance task log data in which an implementation record of a maintenance task, which is a target, is stored; task knowledge data in which knowledge of a target task and asset is recorded; a human machine interface (HMI) that inputs an evaluation setting from a user and presents a result; a simulation basic setting generation unit that generates a current maintenance task simulation based on the maintenance task log data and the task knowledge data; an IoT menu in which details of applicable IoT is listed; an IoT comprehensive scenario generation unit that generates a basic configuration of simulation that incorporates IoT into a simulation basic setting; an IoT adjustment unit that adjusts IoT actually applied in an IoT comprehensive scenario and a performance thereof; a maintenance task simulation unit that executes a maintenance simulation that incorporates the IoT; a simulation result storage unit that stores a result of implemented simulation; and an evaluation unit that evaluates whether an execution result of the simulation meets a maintenance improvement goal of a user.

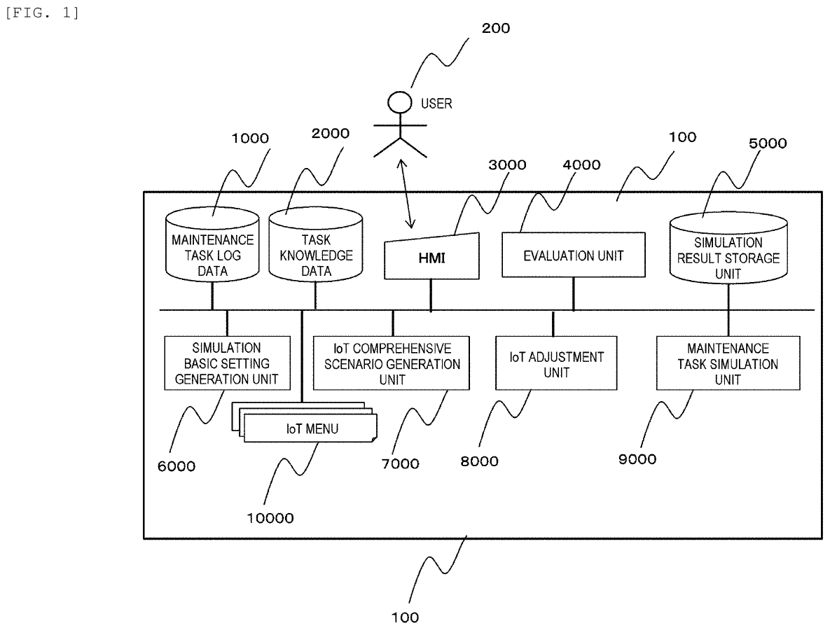

FIG. 1 is a configuration diagram of the maintenance improvement support device of the present embodiment.

A maintenance improvement support device 100 shown in FIG. 1 is a device capable of performing various types of information processing, for example, an information processing device such as a computer. The information processing device includes a processor that configures a control unit and a memory that configures a data storage unit, and further includes a communication interface, an input unit such as a mouse and a keyboard, and a screen unit such as a display, if necessary.

The processor is, for example, a central processing unit (CPU), a graphics processing unit (GPU), a field-programmable gate array (FPGA), or the like. The memory includes, for example, a magnetic storage medium such as a hard disk drive (HDD), a semiconductor storage medium such as a random access memory (RAM), a read only memory (ROM), and a solid state drive (SSD), or the like. Further, a combination of an optical disk such as a digital versatile disk (DVD) and an optical disk drive is also used as a memory. In addition, a known storage medium such as a magnetic tape medium is also used as a memory.

Programs such as firmware are stored in the memory. When an operation of the maintenance improvement support device 100 starts (for example, when a power is turned on), a program such as firmware is read from the memory and executed to perform overall control of the maintenance improvement support device 100. Further, in addition to the program, the memory stores data or the like required for each processing of the maintenance improvement support device 100.

The maintenance improvement support device 100 of the present embodiment may be configured with a so-called cloud in which a plurality of information processing devices can communicate with each other via a communication network.

The maintenance improvement support device 100 shown in FIG. 1 includes maintenance task log data 1000, task knowledge data 2000, an HMI 3000, an evaluation unit 4000, a simulation result storage unit 5000, a simulation basic setting generation unit 6000, an IoT comprehensive scenario generation unit 7000, an IoT adjustment unit 8000, and a maintenance task simulation unit 9000. Hereinafter, a configuration and the function of each unit will be described according to a flow of processing.

The present embodiment is not limited to a specific asset, IoT technology, and maintenance task form, but the following description will be given mainly by taking maintenance of an elevator, auxiliary factory equipment, and a personal computer as examples. At the elevator, workers are dispatched from a regional base to a building where the elevator is installed for maintenance. In the factory equipment, a maintenance department in the factory maintains the equipment owned in the factory. For the personal computer, a maintenance form is assumed that the owner brings the personal computer to the maintenance base and the maintenance is performed on the location.

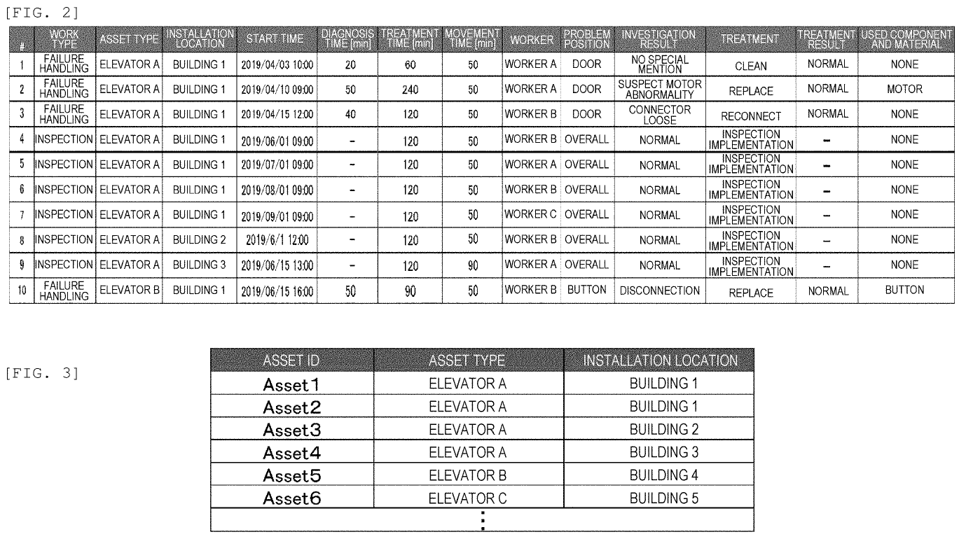

The maintenance task log data 1000 records an implementation result of maintenance such as failure handling and periodic inspections. FIG. 2 shows an example of the maintenance task log data 1000. The maintenance task log data 1000 describes information related to a task classification such as an inspection and failure handling, an ID of an asset that is a maintenance target, an installation location, a work time, a worker, an investigation and treatment result of a problem, or the like.

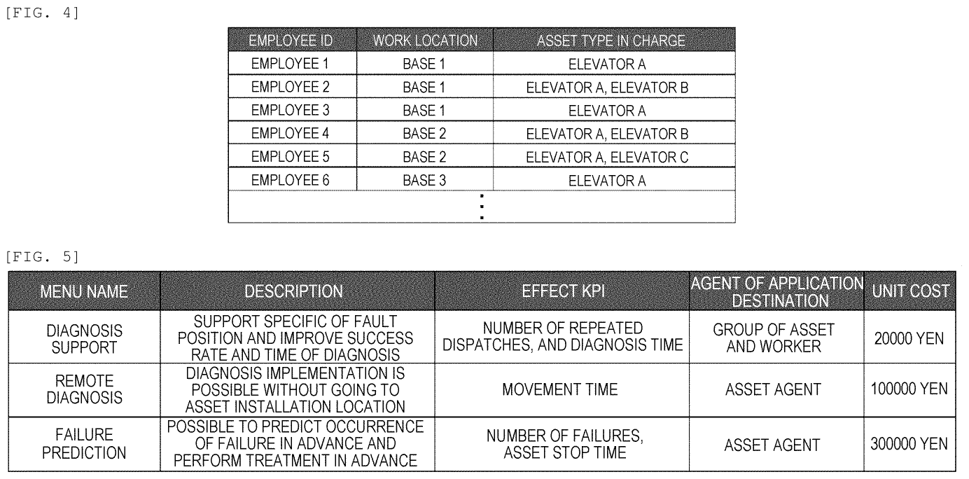

The task knowledge data 2000 stores data of assets and employees that form a task, and provides a list of the assets that are maintenance targets as shown in FIG. 3 and a list of the employees as shown in FIG. 4.

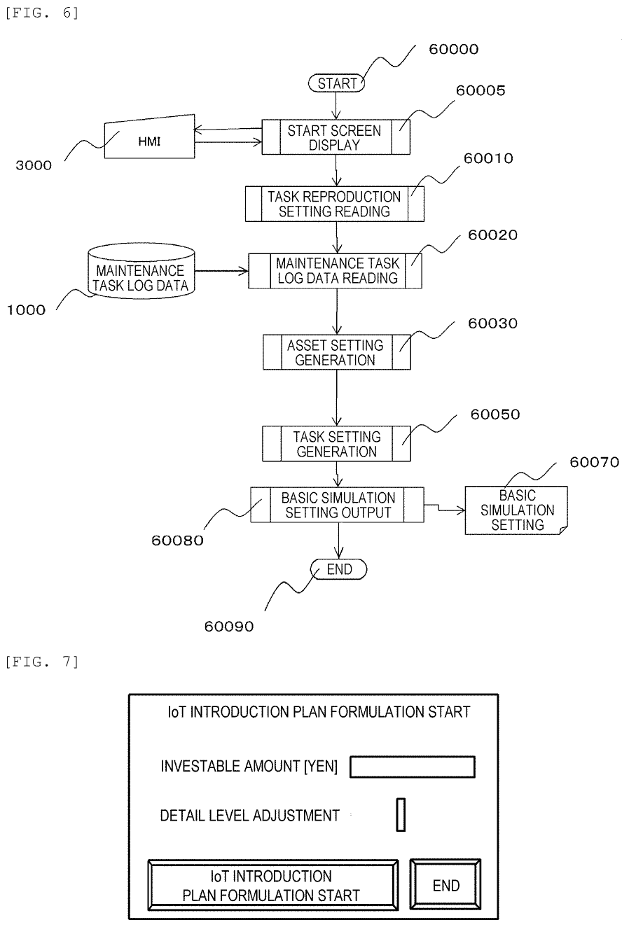

FIG. 5 shows an example of an IoT menu 10000. It is assumed that the IoT menu 10000 lists available maintenance improvement IoT, an effect KPI thereof, an application destination during simulation, and a unit cost during application.

FIG. 6 shows a processing flow of the simulation basic setting generation unit 6000. Hereinafter, the flow will be described.

First, a start screen is displayed on the HMI 3000 for a user, and start processing is performed. FIG. 7 shows an example of the start screen. Here, basically only the start processing is performed, but the IoT comprehensive scenario generation unit 7000, which will be described later, may set a detail level of analysis, input an investable amount in order to generate a plan that fits within the investable amount, and adjust the detail level with a slider or the like. After that, the simulation basic setting generation unit 6000 constructs a simulation that reproduces a current work.

Next, the simulation basic setting generation unit 6000 receives a reproduction setting file of a maintenance status in task reproduction setting reading 60010. It is assumed that the reproduction setting file includes information indicating a range of data used for reproduction, such as a period of the maintenance task log data 1000 used for reproduction, a target asset, and an installation location. It is assumed that the reproduction setting file is created in advance and stored in the maintenance improvement support device 100.

Next, the simulation basic setting generation unit 6000 loads the maintenance task log data 1000 into the memory of the maintenance improvement support device 100 in maintenance task log data reading 60020. At this time, the data to be read is filtered based on the reproduction setting file received earlier.

In asset setting generation 60030, the simulation basic setting generation unit 6000 performs the following processing.

First, in the asset setting generation 60030, a failure handling work occurrence model of an asset to be maintained is generated from a list of assets stored in the task knowledge data 2000 and the maintenance task log data 1000.

Here, for each asset type, a failure handling work occurrence rate per hour for one asset is used for generating the failure handling work occurrence model in which a distribution function is generated based on a work time. FIG. 8 shows an example of a generation result. Here, an example is shown in which a model is constructed in which the work time is shown on a horizontal axis and the work occurrence rate (failure rate) is shown on a vertical axis, and a failure occurs with a low probability when the work time is very long after the failure occurs for a certain period of time or more.

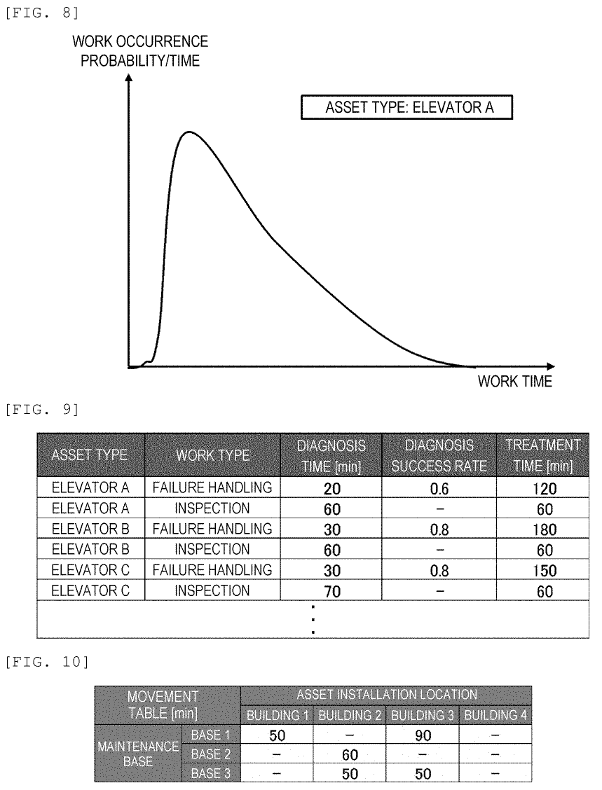

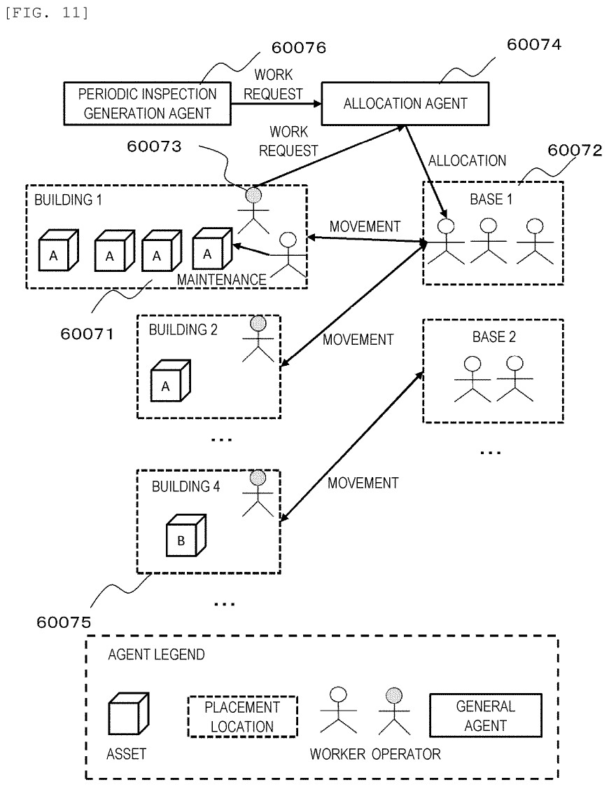

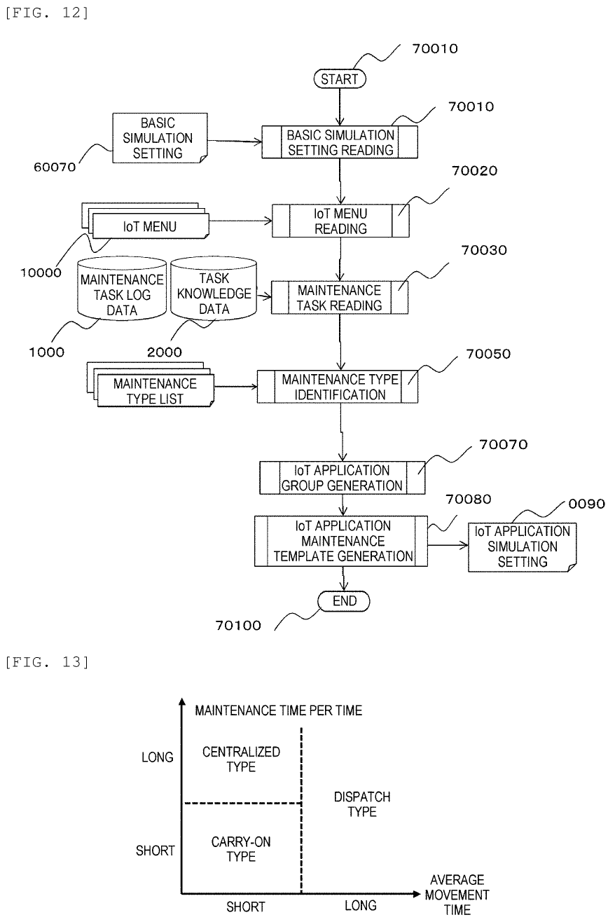

In task setting generation processing 60050, the simulation basic setting generation unit 6000 generates work specifications from actual results by taking statistics on the work time for each asset type and work type based on the maintenance task log data 1000. FIG. 9 shows a generation example. Here, the work specification is generated in units of an asset type, but may be generated in units of components or more detailed failure modes according to a subdivision of a record of the maintenance task log data 1000. Further, a movement time table shown in FIG. 10 can be generated by obtaining a movement time between bases based on the maintenance task log data 1000.

In basic simulation setting output 60080, the simulation basic setting generation unit 6000 generates a setting according to a simulation method from a simulation parameter group created by the simulation basic setting generation unit 6000.

Here, it is assumed that an agent simulation method is used as the simulation method. In agent simulation, for each management unit such as a real-world asset or an asset component, data of the asset corresponding to a simulation world is generated for each individual, and a behavior of the real-world asset is reproduced by the asset autonomously operating and failing. The data generated at this time is called an agent, and in the case of the asset, the data is called an asset agent.

Similarly, each worker also generates an agent in the simulation world and calls the agent a worker agent. The workers perform operations such as waiting, moving, executing task, and resting in response to work instructions. Further, an operation agent that performs an asset operation and makes a failure handling request when a problem occurs, an allocation agent that allocates work to workers, or the like is generated. Details of the execution of the agent simulation will be described in the maintenance task simulation unit 9000.

At this time, in the basic simulation setting output 60080, the simulation basic setting generation unit 6000 sets the required number of agents, the behavior of each agent, the location, or the like according to the task knowledge data and the parameters generated by the simulation basic setting generation unit 6000. Further, placement locations of assets and workers are set, and a movement possibility and a movement time are set according to a movement table between the placement locations.

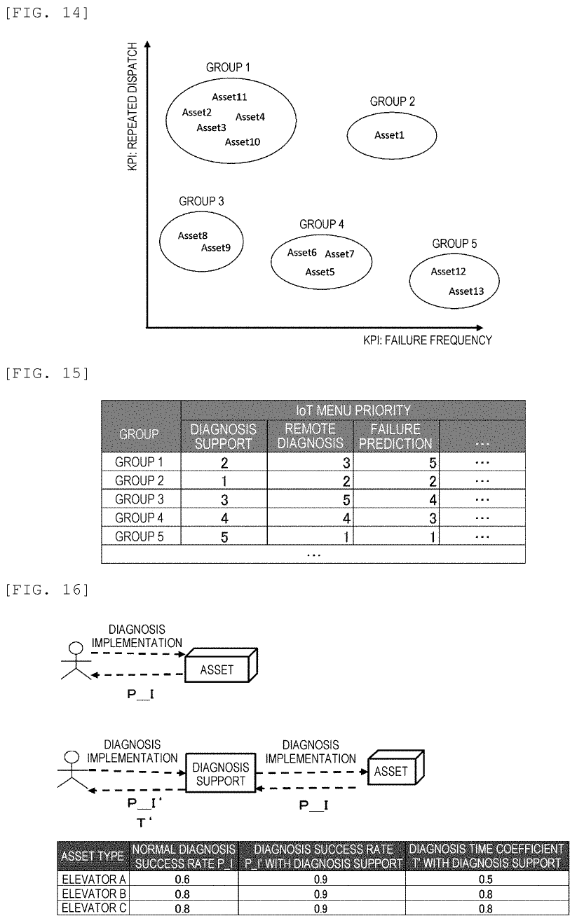

FIG. 11 shows a generation example of a maintenance simulation basic setting. Here, in response to maintenance log data and task knowledge data, two elevators A are placed in a building 1 60071, one elevator B is placed in a building 4 60075, three workers are placed in a base 1 60072, or the like to generate data corresponding to the real world. Further, an operator such as an operator 60073 is generated at each placement location where an asset is placed, and when a failure occurs in the installed asset, a work request is set to be issued to an allocation agent 60074. The allocation agent 60074 issues a work request to the worker in charge. These operations will be described later.

The simulation basic setting generation unit 6000 outputs these simulation settings as basic simulation setting 60070. The output is in memory data and other file formats such as XML. The basic simulation setting is expected to reproduce the existing task.

Next, the IoT comprehensive scenario generation unit 7000 will be described. The IoT comprehensive scenario generation unit 7000 selects an appropriate IoT candidate based on a feature of the maintenance task and incorporates the IoT candidate into the simulation. FIG. 12 shows a flow of the IoT comprehensive scenario generation unit 7000.

The IoT comprehensive scenario generation unit 7000 first reads the basic simulation setting 60070, which is the output of the simulation basic setting generation unit 6000, in basic simulation setting reading 70010. Next, the IoT comprehensive scenario generation unit 7000 reads the IoT menu 10000 in IoT menu reading 70020. Next, the IoT comprehensive scenario generation unit 7000 reads the maintenance task log data 1000 and the task knowledge data 2000 in maintenance task reading 70030.

Next, the IoT comprehensive scenario generation unit 7000 extracts the IoT menu 10000 to be applied by identifying a task form of a target maintenance task in maintenance type identification processing 70050. In the maintenance type identification processing 70050, only the highly effective IoT menu 10000 is filtered or prioritized by identifying an embodiment of a maintenance task based on the read maintenance task log data 1000 and task knowledge data 2000.

This is because, for example, when a maintenance base is far from a base where an asset is installed and the maintenance is performed by dispatching a worker, the movement time becomes long. Therefore, a reduction of the number of dispatches is an effective measure, which includes implementation of a maintenance task such as remote diagnosis, a measure such as diagnosis support for increasing a success rate of local maintenance, a measure for reducing dispatches by lowering a failure rate of assets, or the like.

Alternatively, support for optimizing worker allocation is effective. Typical examples include elevators, ATMs, or the like. In the present embodiment, the maintenance type is called “dispatch type maintenance”.

However, when maintenance workers on the same floor perform maintenance in a factory and plant, the movement time is not a major problem. However, since the impact on the management of one device is large, a failure prediction for preventing unexpected stoppage and a monitoring device that can perform an inspection without stopping are effective. Further, since a maintenance time required for each operation is long, advanced diagnosis support that locally supports the diagnosis of complicated and large-sized equipment is effective. In the present embodiment, the maintenance type is called “centralized type maintenance”.

Alternatively, there may be a case where an asset such as a personal computer or a smartphone is small, and the user brings the asset to a maintenance base for maintenance. In this case, movement is not a problem, but there are more and more cases of replacement with a substitute rather than detailed diagnosis, and the time for one maintenance work is short. In this case, it is effective to reduce the failure rate of the asset itself or to reduce a carry-on amount by remote diagnosis. In the present embodiment, the maintenance type is called “carry-on type maintenance”.

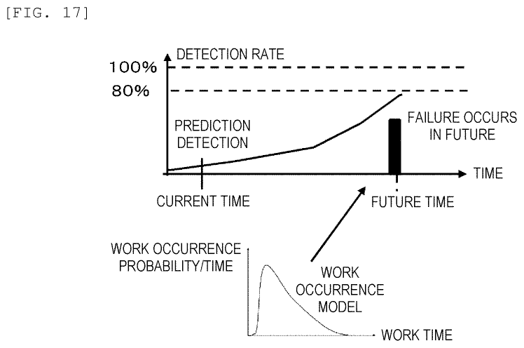

Thus, in the maintenance improvement support device 100 of the present embodiment, it is possible to select an effective IoT menu 10000 by identifying the maintenance type. As shown in the above discussion, the implementation method can be implemented by identifying the movement time and one maintenance time. These indexes can be obtained as an average movement time and an average work time based on the maintenance task log data 1000. FIG. 13 shows a conceptual diagram. An identification reference in the figure may be a value specified by a maintenance engineer or may be determined by machine learning based on various cases.

An appropriate IoT menu 10000 is selected for the maintenance type identified in this way. The selection is implemented based on a coincidence degree between an effect KPI listed in the IoT menu 10000 and a KPI for each maintenance type. Accordingly, the optimum IoT search range can be narrowed down by performing the subsequent processing only for the selected IoT menu 10000 that is effective.

Next, the IoT comprehensive scenario generation unit 7000 performs IoT application group generation processing 70070, which groups an application range estimated to have a high application effect for each IoT candidate. Here, by grouping assets and workers that are IoT application targets into group units that reflect the features of the tasks and determining necessity of applying IoT for each group by simulation to be performed later, it is possible to eliminate the need to determine the application range for each asset or employee, narrow the search range for optimization, and generate effective IoT application settings that reflect task features.

In the present embodiment, the processing is implemented by calculating the effect KPI included in the IoT menu for each asset or worker and performing clustering processing. FIG. 14 shows a conceptual diagram of the clustering processing for an asset. As a clustering method, for example, a method such as k-means can be considered.

Since the determination of the number of clusters depends on a computable amount in optimization computing, the number of clustering is determined by the user according to processing power of the used computer. However, when the number of clusters is increased, the group to which IoT is applied can be generated smaller, so that it is possible to generate a plan of an IoT application range in more detail. For example, when a certain application plan is generated, an application cost of each IoT is determined based on the unit cost in the IoT menu 10000, so that if the application cost exceeds the investable amount specified in advance by the user, it is possible to generate a plan commensurate with the investable amount of the user by rejecting the plan, increasing the number of clusters, and recomputing the number of clusters.

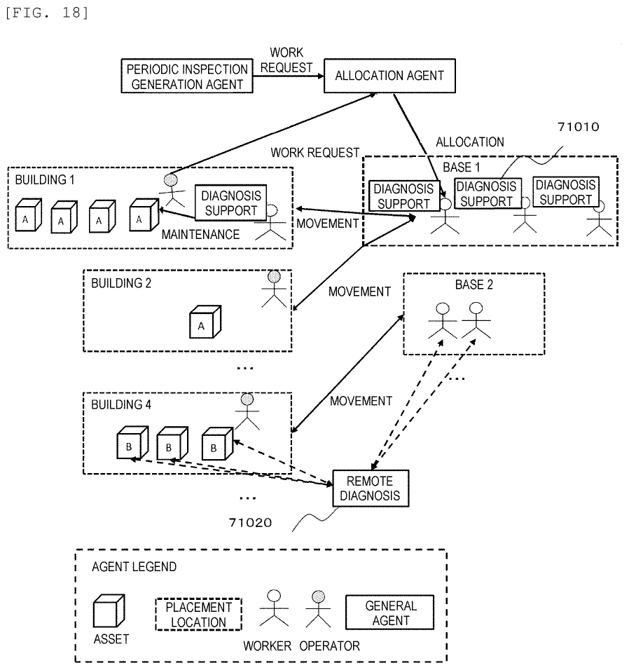

At this time, since the effect KPI is given to each IoT menu 10000, which IoT can be applied to which cluster is determined and prioritized according to the information. As this method, priority is given to a group showing the KPI with bad cluster center on a KPI axis for each IoT menu 10000. Which is better depends on the KPI, so that the determination of good or bad according to the KPI. FIG. 15 shows a generation example. Even for the IoT menu 10000, which is effective for a plurality of KPIs, the priority can be determined by performing the same processing on a synthesized KPI axis.

Similarly, for employees, by performing clustering processing on effect KPIs related to workers, it is possible to generate groups to which IoT is applied and determine priorities. Alternatively, when an IoT agent working on a group of agents of an asset and an employee is set in the IoT menu 10000, the asset and the employee are combined to perform group generation processing by clustering.

Next, the IoT comprehensive scenario generation unit 7000 generates IoT application simulation setting 70090 that incorporates the extracted IoT menu 10000 into the basic simulation setting 60070 as an IoT reproduction agent in IoT application maintenance template generation processing 70080.

Which of the basic agents such as assets, employees, and work allocation is associated with the IoT agent is defined, and by being introduced in the simulation, the effect of IoT can be reproduced by the simulation by changing the operation of each agent.

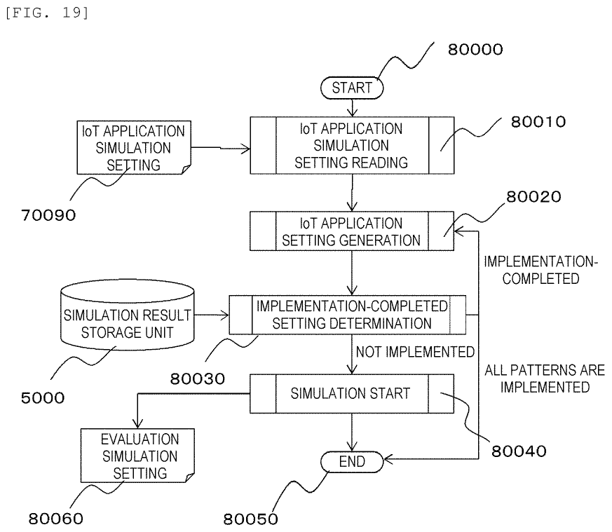

For example, in a case of a diagnosis support agent, when a worker agent performs a diagnosis work, by changing the operation of the worker agent so as to change a success rate and required time of diagnosis, it is effective to improve the success rate and required time of diagnosis. FIG. 16 shows an example of an implementation method. Normally, a success rate of diagnosis implementation is P_I, which is determined for each asset type, but when an employee can use a diagnosis support agent, the success rate of diagnosis implementation is changed to a success rate P_I′ with diagnosis support so that the diagnosis is successful. Accordingly, in a worker workflow of FIG. 20 shown later, a success rate in diagnosis success determination 90060 is changed. Further, it is also possible to reproduce an effect of shortening a diagnosis time by multiplying a normal diagnosis time by a diagnosis time coefficient T′ when there is diagnosis support.

In a case of a remote diagnosis agent, it is possible to perform the diagnosis before the worker moves. Accordingly, by eliminating the movement time during work allocation, it is possible to shorten the success rate and the time of diagnosis by performing diagnosis by a highly skilled worker agent who normally has a high operation rate and is not allocated. Further, after that, a worker agent is dispatched to perform only a treatment work, but since there is no possibility of diagnosis failure because the diagnosis has already been performed, it is possible to prevent the movement due to the diagnosis failure and re-dispatch.

In the worker workflow of FIG. 20, in a case of an applicable asset, remote diagnosis is implemented by skipping movement processing 90030 and 90090 and performing diagnosis implementation 90050. However, even if the diagnosis is successful, the procedure does not proceed to treatment implementation 90120, and by reissuing a failure handling request having a diagnosis result, the treatment based on the diagnosis result, which is successful, is implemented without performing diagnosis in local. The same applies to a case of an inspection, and inspection implementation 90070 is perform without moving, and a failure handling request 90080 is performed only when there is a problem.

In a case of a failure prediction agent, the failure prediction is performed by the asset agent instead of an operator agent who requests the work after a failure occurs. There are various possible methods as this simulation method, but as simulation, it is possible to reproduce by a method such as in the asset agent, the presence or absence of occurrence of future failures is computed up to the previous time according to the failure handling work occurrence model, and when there is a failure within a certain time in the future, a failure is detected with a probability according to an expected failure prediction performance.

FIG. 17 shows an example. In this example, the probability of predicting and detecting a failure increases over time with respect to the occurrence of a failure scheduled for a future time. In this example, a detection rate is 80% instead of 100% even at the time occurrence of failure, and the performance in which a certain failure occurs is reproduced.

Further, it is also possible to reproduce the failure prediction performance such as implementation of occurrence of false alarms with a certain probability. When a failure is predicted and detected, a failure body can be implemented before the failure by issuing a work request to a work allocation agent described later.

Alternatively, when more detailed data and engineering knowledge can be obtained, a method of developing the failure handling work occurrence model, reproducing a deterioration progress of an internal state of an asset with a physical model, and detecting the failure according to the expected failure prediction performance is also conceivable.

Thus, it is possible to simulate various IoT effects by simulation, and it is possible to reproduce the IoT effects by simulation.

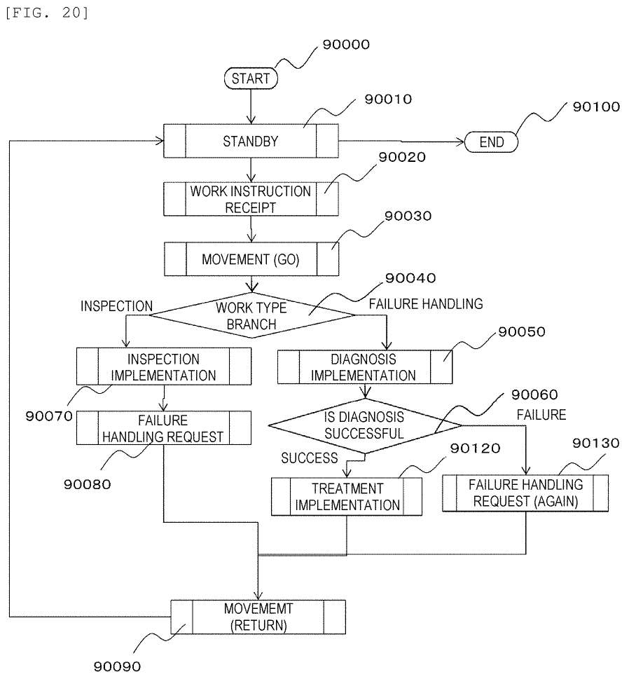

FIG. 18 shows a generation example in dispatch type maintenance. This is an example of introducing a diagnosis support agent and a remote diagnosis agent, and an example in which a worker agent at a base 2 can use remote diagnosis by applying a diagnosis support agent 71010 to each worker at the base 1 and applying a remote diagnosis agent 71020 to elevators B in a building 4.

Then, the IoT comprehensive scenario generation unit 7000 delivers the generated IoT application simulation setting 70090 to the IoT adjustment unit 8000, and the processing of the IoT comprehensive scenario generation unit 7000 is completed.

Next, the IoT adjustment unit 8000 changes, for the IoT application simulation setting 70090 generated by the IoT comprehensive scenario generation unit 7000, simulation settings while enabling and disabling each IoT included in the simulation settings for each group of IoT and an application range according to the given priority, and delivers the IoT application simulation setting 70090 to the maintenance task simulation unit 9000 to simulate the maintenance task incorporating IoT in an order in which the effectiveness is estimated to be high.

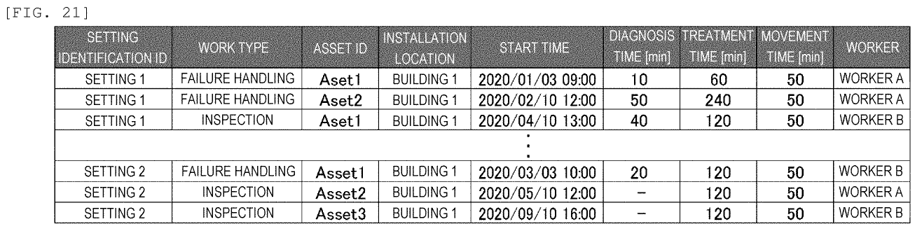

The IoT adjustment unit 8000 searches for an IoT application simulation setting that can obtain an optimum improvement effect by cooperating with the maintenance task simulation unit 9000 and the evaluation unit 4000. Thus, the number of simulation is reduced and a highly effective IoT introduction plan is efficiently generated. FIG. 19 shows a flow of the IoT adjustment unit 8000.

The IoT adjustment unit 8000 first reads the IoT application simulation setting 70090 from the IoT comprehensive scenario generation unit 7000 or the evaluation unit 4000 to be described later.

Next, in IoT application setting generation processing 80020, the IoT adjustment unit 8000 efficiently discovers a highly effective IoT application setting by switching an enabled and disabled state for each group of each IoT agent in the IoT application simulation setting 70090 based on a priority setting.

As an example of this method, the IoT application simulation setting 70090 is read from the IoT comprehensive scenario generation unit 7000 in the first implementation, but at this time, the enabled and disabled state of each IoT is undefined, so that at first, only the group having the highest priority is enabled for a randomly selected IoT agent. When the IoT application simulation setting 70090 is obtained from the evaluation unit 4000 from a second time or later, a method is conceivable to enable the IoT agent for the group, which has the highest priority and is not active, in the randomly selected IoT agent.

Thus, the updated IoT application simulation setting 70090 confirms whether the simulation has already been implemented by the simulation result storage unit 5000 to be described later in which a result of the simulation that has already been implemented is stored, and if the simulation has already been implemented, the processing 80020 is performed again. However, when all possible combinations have already been implemented, the processing is completed. If the simulation is not implemented, the processing proceeds to simulation start processing 80040, the IoT application simulation setting 70090 with an implementation ID given to the maintenance task simulation unit 9000 is delivered, and the processing of the IoT adjustment unit 8000 is completed.

The maintenance task simulation unit 9000 performs prediction simulation of a future maintenance work based on the IoT application simulation setting 70090 delivered from the IoT adjustment unit 8000.

In the present embodiment, agent simulation is used as a simulation method. Therefore, an asset agent causes an asset to fail due to a time alert in the simulation according to the failure handling work generation model, and accordingly, the operator agent issues a failure handling work request to the allocation agent 60074, or the periodic inspection generation agent issues a work request to an allocation generation agent according to a periodic inspection generation setting, so that the maintenance task simulation unit 9000 issues the work request to each worker agent. Further, the worker agent performs the simulation by simulating task execution according to the work specifications in FIG. 9 and the movement time table in FIG. 10. Each agent operates spontaneously as a simulation time elapses, and the operation can be implemented by a method such as a state chart.

FIG. 20 shows an example of the worker workflow. Here, the worker is normally in a standby state 90010, and when work instruction receipt 90020 occurs, the worker moves to an asset according to an instruction. Therefore, worker branches into different works for each work type, and in a case of an inspection, the inspection implementation 90070 is performed, and when a failure is found, a failure handling request 90080 is performed. In a case of failure handling, the diagnosis implementation 90050 is performed, and based on the result, when the diagnosis is successful, the treatment implementation 90120 is performed, when the diagnosis fails, the failure handling request 90130 is performed again, and after the processing is completed, the worker returns to the base in movement 90090.

As discussed earlier, these operations reproduce IoT introduction effects by changing the operations at each stage by the intervention of the IoT agent.

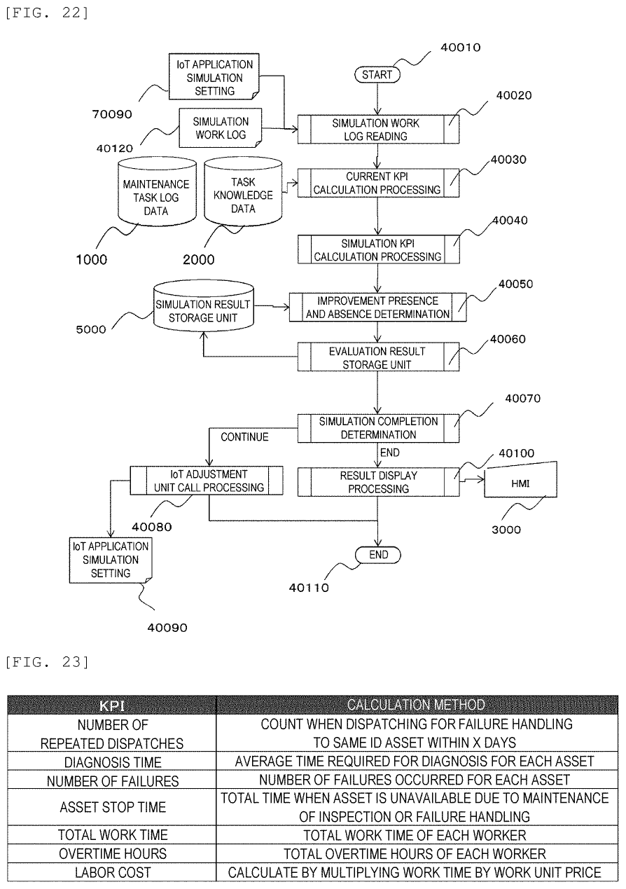

The work result in the simulation is obtained as a work log by the simulation. FIG. 21 shows an example of the obtained result. In the agent simulation, since each agent operates by simulating operations in the real world, the generated log is almost the same as the maintenance task log data 1000, and depending on a detail level of the simulation, there is no information such as detailed handling, but information necessary for evaluation of maintenance results such as a work time and a result is obtained. Further, a setting identification ID corresponding to a setting generated by the IoT adjustment unit is given.

Next, the evaluation unit 4000 calculates a KPI improvement status based on a simulation execution result, and when a larger effect is obtained, records the KPI improvement result at the setting, and based on the setting, further instructs the IoT adjustment unit 8000 so as to generate a new evaluation simulation setting. FIG. 22 shows a flow of the evaluation unit 4000.

First, in simulation work log reading 40020, the evaluation unit 4000 receives the IoT application simulation setting 70090 and a simulation work log 40120 used for the simulation of that time from the maintenance task simulation unit 9000.

Next, in current KPI calculation processing 40030, the evaluation unit 4000 calculates a current maintenance task KPI based on the maintenance task log data 1000. FIG. 23 shows an example of a maintenance KPI to be evaluated. The same KPI can be calculated based on the simulation work log 40120, and is implemented in simulation KPI calculation processing 40040.

The KPIs calculated here can use, in addition to, a KPI that can be directly obtained from the maintenance task log data 1000 and a statistic of simulation results, a KPI that is obtained by multiplying a work time by a unit price and converting a labor cost into a cost, and a high-level KPI such as a KPI collected in any unit.

Next, in improvement presence and absence determination 40050, the evaluation unit 4000 determines whether the KPI is improved at the current simulation setting with respect to the result of the simulation that has already been implemented.

As a method of calculating the KPI improvement effect by a certain simulation setting, it is conceivable to first convert the KPI improvement effect to a monetary value. For example, it is possible to calculate the labor cost based on a total work time, a fine payment for a failure based on the number of failures of an asset, and an opportunity loss due to the failure to operate based on a maintenance time of the asset. Further, depending on a type and a scale of IoT to be introduced, it is possible to calculate a profit improvement KPI as cost effectiveness of an IoT investment by calculating the cost according to a cost calculation method described in the IoT menu 10000. Since the profit improvement KPI is monetary, comparisons between different simulation settings can be clearly performed.

However, some KPI indexes are difficult to convert into money. For example, although it is possible to estimate occurrence of a reduction in customer satisfaction due to the number of failures of an asset and particularly repeated dispatches, it may be difficult to quantify the customer satisfaction, and even if it is possible to quantify the customer satisfaction, it is not always possible to add up the calculation results by different indexes. Alternatively, overtime hours can be converted into money, but it may be necessary to individually reduce overtime hours due to legal regulations, employee satisfaction, and QOL.

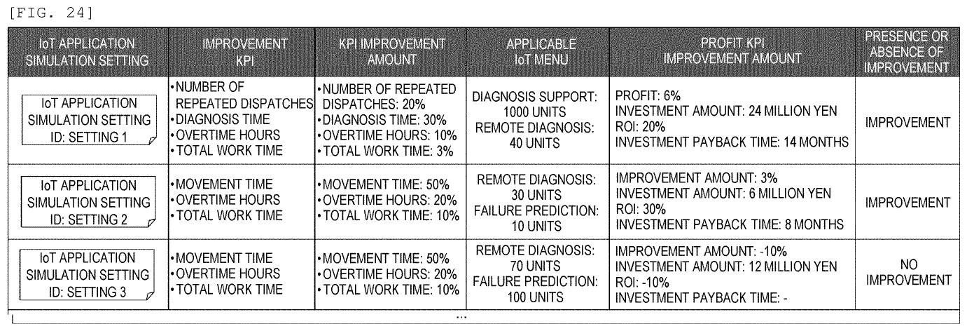

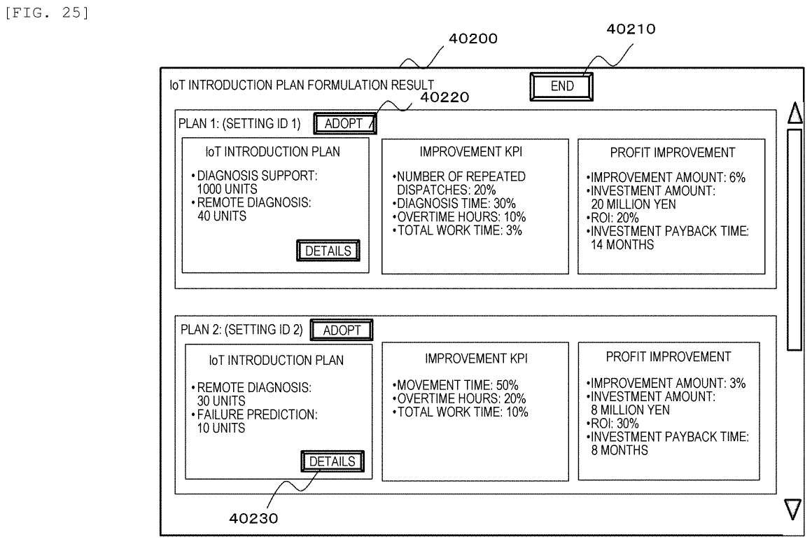

Therefore, in addition to monetary comparison and determination of a numerical improvement of individual KPIs, it is conceivable to investigate the number of types of KPIs that are effective. It is possible to determine whether there is an improvement by comparing a list of KPIs that are effective at each simulation setting, comparing with results of the implemented simulation stored in the simulation result storage unit 5000, and evaluating whether there is any improvement. FIG. 24 shows an example of data of the simulation result storage unit 5000.

The evaluation unit 4000 stores the calculated KPI and the improvement evaluation result into the simulation result storage unit 5000 in the evaluation result storage unit 40060. If there is no improvement at this time, data is stored as no improvement in the improvement result evaluation. Further, the improvement evaluation of the result of the simulation that has already been implemented, which can be determined as no improvement with respect to the current simulation result, is changed to no improvement.

Thus, by using a plurality of indexes such as KPI types in addition to monetary and other numerical indexes, the optimum simulation setting is not unique, but by branching simulation execution so as to optimize monetary and individual KPI improvements for each combination of KPI effect types, it is possible to optimize various IoT configurations that can obtain different improvement effects.

Next, the evaluation unit 4000 performs simulation completion determination 40070. Here, the simulation is completed when the result that is no improvement continues for a certain number of times specified in advance. Alternatively, when the user specifies a KPI and a numerical value thereof in advance as an improvement goal, the computing may be completed when the KPI and the numerical value are satisfied. When the computing is completed, the processing proceeds to result display processing 40100, and when the computing continues, the processing proceeds to IoT adjustment unit call processing 40080.

In the IoT adjustment unit call processing 40080, when an improvement is seen at this setting, the current setting is delivered to the IoT adjustment unit 8000, and the IoT adjustment unit 8000 is instructed to implement new simulation. When no improvement is seen, the setting from the previous execution is delivered to the IoT adjustment unit 8000, and the IoT adjustment unit 8000 is instructed to implement the simulation again. Alternatively, when there is no improvement several times, the settings, which are stored in the simulation result storage unit 5000 and have improvements, are randomly extracted and delivered to the IoT adjustment unit 8000.

In the result display processing 40100, the evaluation unit 4000 lists simulation results that have improvements in the simulation results recorded in the simulation result storage unit 5000, and presents the simulation results to the HMI 3000 for an evaluator 200 (see FIG. 1), which is a user.

FIG. 25 shows an example of a presentation method. The presented simulation results are results of generating an IoT introduction plan that can implement task improvements and optimizing the IoT introduction plan based on effect prediction.

In an example 40200 of a display method shown in FIG. 25, a simulation result storage example shown in FIG. 24 is displayed side by side on a screen, and the user compares and examines an adopted plan from a plurality of IoT application plans. Further, for the plan determined to be adopted, the result may be output to a file or the like and stored by pressing an adoption button 40220.

Further, for the display of the IoT introduction plan, when the user presses a detail button 40230, the details, of which IoT is applied to which assets and employees, may be displayed from the stored IoT application simulation setting 70090. Finally, by pressing an end button 40210, the processing by the maintenance improvement support device 100 according to the present embodiment is completed.

According to the above processing, it is possible to implement the maintenance improvement support device 100 that efficiently formulates the IoT introduction plan based on the features of the target maintenance task in the formulation of the IoT introduction plan based on the maintenance task simulation.

In other words, according to the maintenance improvement support device of the present embodiment, it is possible to implement verification of an IoT effect using the features of the target maintenance task and efficiently implement a desired maintenance task improvement by formulating an optimum maintenance task and IoT introduction plan.

Therefore, in the formulation of the IoT introduction plan based on the maintenance task simulation, which is the purpose of the present embodiment, it is possible to select, based on extraction of a task form of the target maintenance task and extraction of features of an asset and a failure, an asset to be applied and a candidate of users for each type of IoT that is an introduction candidate, and to efficiently formulate, by optimizing the applicability and the performance by simulation, an optimum IoT introduction plan that implements a maintenance improvement goal.

The embodiment described above have been described in detail for easy understanding of the invention, and the invention is not necessarily limited to those including all the configurations described above. Another configuration can be added to, deleted from, and replaced with a part of the configuration of the embodiment.

Further, the configurations, functions, processing units, processing means, or the like may be implemented by hardware by designing a part or all of them with, for example, an integrated circuit. Further, the invention can also be implemented by program code of software that implements the functions of the embodiment. In this case, a storage medium recording the program code is provided to a computer, and a processor included in the computer reads out the program code stored in the storage medium. In this case, the program code itself read out from the storage medium implements the functions of the above embodiment, and the program code itself and the storage medium storing the program code constitute the invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

Further, for example, the program code that implements the function described in the present embodiment can be implemented by a wide range of programs or script languages, such as an assembler, C/C++, perl, Shell, PHP, Java (registered trademark), and Python.

Further, the program code of the software that implements the function of the embodiments may be stored in a storage device such as a hard disk or a memory of a computer or a storage medium such as a CD-RW or a CD-R by delivering via a network, and a processor included in the computer may read out and execute the program code stored in the storage device or the storage medium.

In the embodiments described above, control lines and information lines are considered to be necessary for description, and all control lines and information lines are not necessarily shown in the product. All configurations may be connected to each other.

### REFERENCE SIGN LIST

100 maintenance improvement support device
200 evaluator
1000 maintenance task log data
2000 task knowledge data
3000 HMI
4000 evaluation unit
5000 simulation result storage unit
6000 simulation basic setting generation unit
7000 IoT comprehensive scenario generation unit
8000 IoT adjustment unit
9000 maintenance task simulation unit
10000 IoT menu

1. A maintenance improvement support device, comprising:
maintenance task log data in which an implementation record of a maintenance task, that is a target, is stored;
task knowledge data in which knowledge related to the maintenance task is recorded;
a simulation basic setting generation unit configured to generate, based on the implementation record and the knowledge of the maintenance task, a basic simulation setting that reproduces a current maintenance implementation status;
an IoT menu in which an available IoT solution candidate, and an effect and an application method thereof are recorded;
an IoT comprehensive scenario generation unit configured to extract an applicable IoT menu in the IoT menu from a feature of the maintenance task that is a target, determine or prioritize simulation elements such as an asset and an employee as actual application targets based on the feature of the maintenance task, and generate an IoT application simulation setting that incorporates available IoT into the basic simulation setting;
an IoT adjustment unit configured to sequentially execute IoT application simulation while selecting the asset and the employee who actually perform an IoT application evaluation for the IoT application simulation setting;
a maintenance task simulation unit configured to execute maintenance task simulation that incorporates the IoT;
a simulation result storage unit configured to store a result of the maintenance task simulation that has already been implemented; and
an evaluation unit configured to give an instruction to the IoT adjustment unit to implement a next IoT application simulation so as to optimize an improvement by determining presence or absence of a task improvement based on the stored result of the maintenance task simulation, and present an improvement result when the IoT application simulation is completed.

2. The maintenance improvement support device according to claim 1, wherein
the IoT comprehensive scenario generation unit is configured to evaluate an applicability of the IoT for each group by extracting a feature amount of the maintenance task from the maintenance task log data or the task knowledge data and grouping the asset and the employee related to the maintenance task.

3. The maintenance improvement support device according to claim 2, wherein
the IoT adjustment unit is configured to evaluate an expected application effect of the IoT for the grouped asset and employee, and at this time, sequentially evaluate the expected application effect of the IoT from the group that is considered to be highly effective.

4. The maintenance improvement support device according to claim 1, wherein
the IoT comprehensive scenario generation unit is configured to reproduce simulation of current maintenance that reproduces a current maintenance task as agent simulation that individually simulates an operation of each maintenance-related element, and incorporate an agent that reproduces an effect of the IoT into an applicable location of the IoT in a setting of the simulation of the current maintenance so as to reproduce an assumed effect at the time of applying the IoT, in order to generate the IoT application simulation setting.

5. The maintenance improvement support device according to claim 2, wherein
the evaluation unit is configured to, when an IoT introduction plan in which an investment amount is reduced is not generated because the generated group is large, generate the IoT introduction plan in which a setting of an application range is further subdivided by sequentially subdividing and reevaluating a division of the group such that an IoT investment amount fits within an investable amount set by a user.

6. The maintenance improvement support device according to claim 2, wherein
the IoT comprehensive scenario generation unit is configured to, when the asset and the employee are grouped, implement the grouping by calculating, for a set of indexes of the maintenance task in which a plurality of the available IoT is expected to have an improvement effect, the set of the indexes of the maintenance task in the current maintenance task for each of the asset and the employee, and defining a distance between the set of the indexes of the maintenance task and performing clustering processing that groups the asset and the employee who are close to each other as a group.

7. The maintenance improvement support device according to claim 3, wherein
the evaluation unit is configured to, for an evaluation result of each IoT introduction plan, calculate a change from the current maintenance task of the indexes of the maintenance task in implementation of each evaluation, and formulate and present, by using an increase of the indexes for which an improvement is obtained or an individual improvement of each index as a determination reference of realization of improvement, a plurality of the IoT introduction plans for which an improvement is obtained.

8. A maintenance improvement support method using a maintenance improvement support device,
the maintenance improvement support device including:
maintenance task log data in which an implementation record of a maintenance task, which is a target, is stored;
task knowledge data in which knowledge related to the maintenance task is recorded; and
an IoT menu in which an available IoT solution candidate, and an effect and an application method thereof are recorded,
the maintenance improvement support method comprising:
generating, based on the implementation record and the knowledge of the maintenance task, a basic simulation setting that reproduces a current maintenance implementation status;
extracting an applicable IoT menu in the IoT menu from a feature of the maintenance task that is a target, determining or prioritizing simulation elements such as an asset and an employee as actual application targets based on the feature of the maintenance task, and generating an IoT application simulation setting that incorporates available IoT into the basic simulation setting;
sequentially executing IoT application simulation while selecting the asset and the employee who actually perform an IoT application evaluation for the IoT application simulation setting;
executing maintenance task simulation that incorporates the IoT and storing a result of the maintenance task simulation that has already been implemented; and
giving an instruction of implementing a next IoT application simulation so as to optimize an improvement by determining presence or absence of a task improvement based on the stored result of the maintenance task simulation and presenting an improvement result when the IoT application simulation is completed.
